(19) United States
(12) Patent Application Publication
(10) Pub. No.: US 2026/0184399 A1
(43) Pub. Date: Jul. 2, 2026

(54) Electric Bicycle and Charging Device for Use in Such an Electric Bicycle

(71) Applicant: MA Micro Limited, London (GB)

(72) Inventors: Olivier Hébert, London (GB); Ahmet Serhan Kuscuoglu, London (GB); Jiun Peng Gu, London (GB); Mao-Chieh Tang, London (GB); Chien I Chen, London (GB); Mykola Zaitsev, London (GB); Tim Stegeman, London (GB)

(21) Appl. No.: 18/846,929

(22) PCT Filed: Mar. 14, 2023
(86) PCT No.: PCT/NL2023/050129

§ 371 Date: Sep. 13, 2024

(30) Foreign Application Priority Data
Mar. 15, 2022 (NL) 2031283

(51) Int. Cl. B62K 23/02; B62J 3/10; B62J 45/20; B62J 50/20; B62K 21/12

(52) U.S. Cl. CPC B62K 23/02; B62J 3/10; B62J 45/20; B62J 50/20; B62K 21/12

(57) ABSTRACT

The invention relates to an electric vehicle, in particular an electric bicycle, including a bicycle frame, said bicycle frame including a substantially vertically extending frame part, in particular a head tube and a steering system mounted to said bicycle frame. The invention also relates to a first control unit for use in such an electrical vehicle, in particular electric bicycle. The invention further relates to a steering system for use in such an electrical vehicle, in particular electric bicycle.

### CROSS-REFERENCE TO RELATED APPLICATIONS

This application is the United States national phase of International Patent Application No. PCT/NL2023/050129 filed Mar. 14, 2023, and claims priority to The Netherlands Patent Application No. 2031283 filed Mar. 15, 2022, the disclosures of which are hereby incorporated by reference in their entireties.

### BACKGROUND OF THE INVENTION

### Field of the Invention

The invention relates to an electric vehicle, in particular an electric bicycle, comprising a bicycle frame, said bicycle frame comprising a substantially vertically extending frame part, in particular a head tube and a steering system mounted to said bicycle frame. The invention also relates to a first control unit for use in such an electrical vehicle, in particular electric bicycle. The invention further relates to a steering system for use in such an electrical vehicle, in particular electric bicycle.

### Description of Related Art

Over the last 150 years, the bicycle has evolved to become one of the most efficient means of transportation in terms of conversion of energy into distance travelled. The efficiency of the bicycle has also been optimized to minimize the effort required by the rider. For instance, most modern bicycles include an efficient gear system to minimize rider effort. To further reduce the amount of human effort required to propel a bicycle, a variety of electric bicycles (e-bikes) have been introduced, wherein use is made of an electromotor as auxiliary power source to assist the manpowered pedalling process. Due to the presence of onboard electrical power, the electrical power is also more and more used to power further onboard electronic components, which has resulted in a significant increase in the number of cables used within the bicycle frame as well as continuously increasing complexity of the onboard logistics to control all different electronic components.

### SUMMARY OF THE INVENTION

It is a first object of the invention to provide an improved electric bicycle, wherein the cable routing within the bicycle is simplified while still allowing a plurality of electronic accessories to be controlled.

It is a second object of the invention to provide an improved electric bicycle, wherein the risk of cable damage within the bicycle during normal use of the bicycle is significantly reduced, while still allowing a plurality of electronic accessories to be controlled.

At least one of these objects can be met by providing an electric bicycle, comprising:
a bicycle frame, comprising a, preferably substantially vertically extending and/or inclined, frame part, in particular a head tube,
a steering system, comprising:
   a steering assembly, comprising:
      a fork comprising a steerer tube being at least partially inserted in said frame part, wherein said fork is rotatably secured to said frame part, and
      a handlebar fixedly connected to said steerer tube,
   a plurality of electronic accessories mounted to said steering assembly, in particular to said handlebar,
at least one first control unit, in particular an accessory control unit, preferably mounted to said steering assembly, in particular to said handlebar, wherein each of a plurality of electronic accessories is connected by at least one accessory cable to said first control unit, and wherein the first control unit is additionally connected or connectable to at least one control cable and/or at least one power cable, wherein the number of said accessory cables exceeds the total number of control cables and/or power cables (simultaneously) connected or connectable to said first control unit.

Preferably, one or more accessory cable, and more preferably each accessory cable, is/are entirely accommodated within the steering assembly, in particular in the handlebar. This routing of the accessory cables within the steering assembly, in particular within the handlebar, shields and protects the accessory cables. This makes the accessory cables less vulnerable for damage and sabotage. Moreover, such an internal cable routing within the steering assembly leads to an improved safety of the electric bicycle, as this will prevent the accessory cables from snagging and catching on to other objects and/or other people.

Preferably, the bicycle comprises at least one second control unit, in particular a main control unit, preferably mounted to said bicycle frame, wherein said first control unit is connected by at least one control cable, directly or indirectly, to said second control unit, and wherein the number of said accessory cables exceeds the number of control cables. The control cable may be configured to also act as power cable to power the first control unit.

Preferably, at least one of said electronic accessories, more preferably each electronic accessory, is a powered electronic accessory for powering at least one electronic component of said electronic accessory.

Electronic accessories typically require a predetermined power and/or input signal in order provide for the desired functionalities. To this end, the accessories may be connected to a second control unit, in particular a main control unit, via an accessory cable. However, when the amount of electronic accessories mounted to the steering assembly increases, also the amount of accessory cables increases. This may cause problems in routing the cables towards the main control unit. The high number of cables may risk damage under normal use. All these accessory cables are normally exposed to the open air, which may increase the risk of damage even further. In order to reduce the risk of damage it may be of benefit to reduce the amount of cables required for controlling and/or powering the electronic accessories. To this end, the number of accessory cables exceeds the number of control cables (and/or power cables). Since the control cables extend over a longer part of the bicycle, this reduces the risk of damage to the cables since the number of control cables (and/or power cables) is reduced. The lower the number of cables, the lower the chances are of damaging one of said cables. Also, since the first control unit may be mounted to the steering assembly, it is in fact mounted in a region where the stationary part of the bicycle, i.e., the frame itself, finds its transition into the moving parts of the bicycle, i.e., the handlebar and/or steering assembly, this requires a lower number of cables to find space for rotation. This may yield an improved routing of the cables of the bicycles, in particular a simplified routing. That is, preferably all accessory cables are connected to one electronic accessory on one side, and to the first control unit on the other side thereof. This allows that preferably all accessory cables start on the steering assembly and also end on the steering assembly, since this is where the first control unit is mounted. Hence, preferably all accessory cables are entirely located or mounted on the moving part of the bicycle, which may eliminate at least a part of the friction which may be caused when these accessory cables extend to the stationary part and under movement of the moving part with respect to said stationary part. The at least one control cable extends from the first control unit to the second control unit, in particular the main control unit. Hence the at least one control cable is preferably extends from the moving steering assembly towards a stationary part, such as a tub tube, of the bicycle frame. Since the number of control cables extending from the first control unit to the main control unit is smaller than the number of accessory cables, the friction, wear and tear caused by cables routed from the moving part, in particular the steering assembly, to the stationary part, in particular a frame member such as the top tube, may be reduced. The reduction of the number of cables routed from the moving part to the stationary part allows to reduce the friction induced by said cables. Besides the reduced friction, which may increase the lifespan of the cables, it turned out that the present invention may also provide for less entrapment of the cables. This effect may, inter alia, be contributed to the reduced number of cables running from the steering assembly to the stationary part, as compared to the number of cables running from the accessories to the first control unit.

It is conceivable that the substantially vertically extending frame part, in particular the head tube, is at a slight angle. That is, it is conceivable that said frame part encloses an angle, at least during use, with respect to a ground plane. Preferably said angle is situated between 75 degrees and 115 degrees.

Moreover, the cables typically have a certain stiffness, which may, when a significant number of cables is routed from the moving part, in particular the steering assembly, to the stationary part, require the user to use a significant amount of force to rotate the handlebar. This is undesired, since steering the bicycle should be easy and comfortable in order to provide for a comfortable ride. The present invention therefore may also contribute to a more comfortable ride due to the configuration. That is, the reduced amount of cables running from the moving part, in particular the steering assembly, to the stationary part of the bicycle, in particular while allowing an increased amount of functionalities on the steering wheel. This configuration may allow for a smoother steering experience of the bicycle. Functionalities of the handlebar may be increased without having to increase the number of cables extending from the moving part, in particular the steering assembly, to the stationary part. This may be possible due to the first control unit. The first control unit is preferably configured for converting a signal received from the main control unit via the at least one control cable into a control signal for each of the electronic accessories.

Stationary parts of the bicycles may be understood as parts of the bicycle which are not movably mounted. Parts such as a saddle, which may be movable once a connection is loosened, may also be understood as stationary. The head tube, for example, may be seen as a stationary tube, which is generally not configured for moving. The moving parts of the bicycle may be understood to be movable in use. In particular said moving parts are movable with respect to the stationary parts. The steerer tube, handlebar, a stem of the handlebar, wheels may for example be contemplated as moving parts of the bicycle.

Preferably, the first control unit is connected to a single control cable and/or a single power cable. It is imaginable that the bicycle does not comprise a second control unit and/or that the bicycle does comprise a second control unit which is not connected to the first control unit. It is imaginable that the first control unit is merely connected to a plurality of accessory cables and a single power cable. However, it is typically preferred that the second control unit is applied, and connected, directly or indirectly, to the first control unit, in order to exchange data, such as one or more control signals, with between both control units, and optionally to power the first control unit by the second control unit via at least one interconnected power cable. Preferably, the first control unit is connected to the second control unit by means of a single control cable (which may or may not also be configured as power cable). This may allow for the largest reduction of cables extending from the moving part to the stationary part. Therefore, the smoothest steering may be achieved. Also, routing only a single control cable from the moving part to the stationary part allows for a relatively simple cable routing, which may also yield less damage or breakage. The risk of cables getting entrapped may be essentially removed since merely a single control cable and/or power cable extends from the moving to the stationary part of the bicycle. According to an embodiment it is conceivable that the first control unit comprises a plurality of accessory connectors, each of which being configured to be connected to at least one accessory, preferably via said accessory cables. Since the first control unit is mounted onto the steering assembly, in particular to the handlebar and/or the stem of the handlebar, this may cause the accessory cables to essentially exactly follow the movement of the steering assembly, in particular the handlebar. Hence, the accessory cables do not move with respect to the steering assembly, in particular the handlebar, in particular during a steering movement. As such, entrapment may be reduced significantly. Preferably, the first control unit comprises a single control unit connector configured to be connected, directly or indirectly to the second control unit, preferably via the single control cable. Hence, the first control unit may comprise a plurality of accessory connectors and a single control connector. The plurality of accessory connectors may be housed on a single connector, or may be housed in a plurality of independent connectors.

According to a preferred embodiment at least one accessory cable is configured to transfer power from the first control unit to the accessory connected to said accessory cable. Preferably, at least one accessory cable is configured to transfer data between the first control unit and the accessory connected to said accessory cable. More preferably, at least one accessory cable is configured to transfer data and power from the first control unit and the electronic accessories. The accessory cables allow the electronic accessories to be used independently of one another. Preferably each of the accessory cables may transfer power and/or data from the first control unit to an electronic accessory. This may allow one accessory to remain off, while one or more of the other electronic accessories are in use.

Preferably, at least one control cable is configured to transfer power from the second control unit to the first control unit. It is conceivable that at least one control cable is configured to transfer data between the second control unit and the first control unit. Allowing a transfer of power from the first control unit to the second control units may eliminate the need for a separate power source located and/or connected to the first control unit. To this end it is of benefit that power may be transferred from the main control unit, which may be mounted in a frame tube, towards the first control unit, which may be mounted on the steering assembly. It is preferred that the at least one control cable is configured for transferring both power and data from the second control unit, in particular the main control unit, to the first control unit. The data may comprise information related to at least one electronic accessory, such as a power off or power on signal.

It is conceivable that the first control unit is configured to transform a voltage received from the main control unit into a voltage suitable for the electronic accessories. The power that is transferred via the at least one control cable from the second control unit to the first control unit may have a power which is not suitable for use in at least one electronic accessory. This may be the case when for example the Voltage of the power is situated at 12 V, and/or 24 V, and/or 48 V. Some electronic components may required a deviating voltage, such as 3 V, and/or 5 V. To this end, the first control unit may be configured to function as a voltage transformer. It is for example conceivable that at least two electronic components function at mutually deviating voltages. The first control unit may transform the power received, via the control cable, from the second control unit, into a plurality of accessory power signals at a voltage level corresponding to the voltage requirement of said electronic component. Said transformation of the power may occur simultaneously, such as parallel, for each of the electronic accessories, or may occur serially. According to a preferred embodiment the first control unit comprises a transformer, in particular a voltage transformer. Said voltage transformer may be integral part of the first control unit, for transforming an input voltage received into an output voltage to be sent out. Hence, the first control unit is preferably configured as power hub (and/or volage hub and/or current hub) to distribute and/or to control power (and/or voltage and/or current) provided to one or more, preferably all accessory cables, and consequently to one or more, preferably all accessories.

According to a preferred embodiment at least one control cable and/or at least one accessory cable is a bicycle bus cable, in particular a CAN bus cable, and/or is connected to a bicycle bus, in particular a CAN bus, wherein said bicycle bus is connected to the second control unit. Preferably, the first control unit comprises a communication protocol converter for mutual conversion between a input CAN bus signal and at least one serial signal, preferably a multipath serial signal and/or an output CAN bus signal. The CAN bus signals may allow to reduce the need for excessive cables since the electronic accessories and/or first control unit and/or second control unit to communicate with each other. Moreover, the CAN bus protocol is durable and reliable, which are key areas of concern, in particular for e-bikes. Preferably, at least one control cable (and/or power cable) and/or at least one accessory cable comprises a plurality of wires, such power wires, shielding wires, and/or data wires.

It is conceivable that the first control unit functions as a distribution hub for the power and/or signals. That is, the first control unit may receive data, in particular a data signal from the second control unit, and convert said received data signal into an instruction data signal for at least one electronic accessory, preferably into a plurality of instruction data signals for a plurality of electronic accessories. Moreover, said hub may also be configured for converting an input power received from the second control unit into an accessory power, for powering at least one electronic accessory. Preferably for converting said input power into a plurality of accessory powers, for powering a plurality of electronic accessories. As such, the first control unit may essentially eliminate the cable imposed restrictions. Hence, the number of electronic accessories mounted on the steering assembly may be increased without increasing the number of cables extending from the moving part, in particular the steering assembly, to the stationary part. Hence, the smooth steering may be maintained even while increasing the number of electronic components. This allows for more design freedom and simplified routing of the handlebar.

According to an advantageous embodiment the at least one control cable (and/or power cable) is partially accommodated within said frame part, in particular said head tube, and is partially accommodated within at least one connecting adjacent frame part, such as a top tube or down tube, of the bicycle frame. It is also conceivable that at least one accessory cable is at least partially accommodated within a part of the handlebar, preferably all accessory cables are routed inside the handlebar. Routing the at least one control cable (and/or power cable) and/or at least one accessory cable through an interior part of a tube may further protect the cables from wear and tear. Internal routing may moreover prevent vandals from cutting cables of the electronic accessories. Preferably, the at least one control cable (and/or power cable) is at least partially routed through the steerer tube. Preferably, the steerer tube comprises at least one lateral opening, for routing therethrough at least the at least one control cable. Said lateral opening allows the control cable (and/or power cable) to enter the top tube and/or the bottom tube of the bicycle frame. To this end, the lateral opening of the steerer tube debouches in the opening of the top tube and/or bottom tube, preferably an intersecting location thereof. Preferably the handlebar comprises two opposing user grips mutually connected by a tubular body, wherein at least one, preferably each, accessory cable is guided into said tubular body, wherein preferably at least one accessory cable is partially enclosed by one of the grips and the tubular body. Preferably, at least one accessory is positioned adjacent or close to one of the grips, and wherein preferably at least one accessory is positioned adjacent or close to one of the other grips. This may allow for a compact packaging of the electronic accessories.

Preferably, the first control unit comprises a shielding element, which shielding element is at least partially exposed. The shielding element may protect the control unit, or components inside the control unit from external impact. According to a preferred embodiment, the first control unit comprises at least one environmental sensor for measuring values relating to at least one environmental related parameter. Preferably wherein the environmental sensor is chosen from the group consisting of: a temperature sensor, a light sensor, an oxygen sensor, a carbon dioxide sensor, an air pollution sensor, and an audio sensor, such as a sound sensor or noise sensor. It is conceivable that the first control unit and/or the second control unit is programmed to generate at least a part of at least one control signal based upon at least value measured by at least one sensor, wherein said control signal is configured to control at least one electronic component, such as an electronic accessory, of the electric bicycle. Allowing the sensors for generating at least one control signal may provide for additional functionality and an improved control of the bicycle. For example, the light sensor may be used to determine when it is dark, in order for decorative lights and/or functional lights on the steering assembly to be turned on, or an intensity to be increased, by the first control unit. The oxygen sensor and/or the carbon dioxide sensor and/or air pollution sensor may be used for determining and/or detecting a more healthy direction of travel. A warning may e.g. be provided to a user via at least one electronic accessory if the carbon dioxide level and/or pollution level increases a predefined level. Preferably, the shielding element comprises holes for exposing the one or more sensors, positioned behind said shielding element, to the environment. Hence, the holes may establish a connection for allowing the sensors to detect the different characteristics of the environment. Preferably, the second control unit is partially exposed.

According to a preferred embodiment, the first control unit comprises at least one, preferably exposed and/or accessible, powered device charging port for charging an external device, such as a smartphone, wherein the device charging port is preferably covered or coverable by at least one device charging port cover element. Said charging port may be arranged on the shielding element, preferably the charging port is at least partially covered by means of a removable cover element. Said cover element is preferably configured for covering the charge port to prevent moisture and/or water from entering the charging port. The cover element may be movably attached to the first control unit, preferably movable between a closed position, wherein the cover element at least covers the charging port, and an opened position, wherein the charging port is at least partially accessible. It is also conceivable that the first control unit comprises at least one, preferably exposed and/or accessible, bicycle charging port configured to co-act with an external charging port of a charging terminal for charging said bicycle via said charging terminal, wherein the bicycle charging port is preferably covered or coverable by at least one bicycle charging port cover element. Preferably, the charging port comprises a cover element for covering said charging plug, wherein the cover element is displaceable between an covered position, wherein the charging plug is covered, preferably watertightly sealed, by said cover element, and uncovered position, wherein the charging plug is left at least partially uncovered to allow the charging plug to co-act with the external plug, wherein the cover element is preferably pivotably and/or slidably connected to a housing of the charging device. The cover element is preferably at least partially composed out of a resilient material, such as a rubber or polymer material having similar material properties. This allows the cover element to seal the charging plug. Additionally this allows the cover element to be connected on one side and hinged through its resilient and/or flexible properties. The resilient cover element may be attached to the frame and/or the charging device on one location, wherein the cover element may be hinged or folded around said location. The cover element may be attached to the charging device by means of an adhesive, and/or via bolts or screws, and/or by means of clamping.

Preferably, the first control unit comprises at least one, preferably exposed and/or accessible, servicing port configured to co-act with an external servicing port of a servicing terminal for servicing said bicycle via said servicing terminal, wherein the servicing port is preferably covered or coverable by at least one servicing port cover element. The cover element may protect the service port in case it is not in connection with an external port of a service terminal. The cover element at least covers the electrical connectors of the service port. Preferably, the cover is configured to cover at least the electrical connectors of the service port substantially impermeable to water and/or moisture. The cover may be entirely removable from the service port or may be movably attached. If the cover is entirely removable, it may for example be clamped such as to cover the service port of the bicycle. If it is movably attached, a part of the cover may be attached via screws, bolts, glue or by clamping. Preferably, the cover is movable between an opened position, wherein at least the electrical connectors of the service port are accessible, at least for connecting an external port, and a closed position, wherein the cover covers at least a part of the service port, preferably at least the electrical connectors. Although the service port is preferably waterproof, the cover element may provide for an additional water barrier and therefore may increase the protection against water. The main goal of the cover element is to prevent the service port from external impact that may damage the service connector. Also, the cover may provide for protection against sabotage by for example malicious persons or persons trying to impede into the bicycles systems without being authorized to do so. To this end, the cover element may be screwed or bolted to a part of the bicycle. Preferably temper resistant screws, e.g., secured screws that may only be unscrewed with special tools, are used for fastening the cover in this respect. According to a preferred embodiment the first control unit comprises at least one generator for generating at least one visual and/or auditory signal. Said generator may warn a user and/or make a user aware of a predefined situation. For example, if a threshold of a carbon dioxide level is exceeded, a user may be warned that this level is high.

According to a preferred embodiment, the at least one control cable and/or power cable comprises at least a coiled section (helical section) and/or spiralled section. Preferably said coiled section and/or said spiralled section are accommodated within the head tube and/or within the steerer tube. Said coiled section and/or said spiralled section allows for providing a predefined play in the length of the cables. That is, the coiled section and/or the spiralled section may easily extend, at least temporarily, in length, in order to absorb movement. This provides more flexibility, and may prevent extensive pulling forces to be exerted onto the cables. Preferably, the steerer tube is a hollow tube, wherein said steerer tube comprises a threaded portion. The steering assembly may further comprise a lock nut, for locking, or tensioning, the steerer tube. Said steerer tube comprises an internal threaded section, and wherein the lock nut comprises an externally threaded segment. The co-acting threaded sections allow to remove and/or adjust the play of the fork and/or handlebar. Preferably, the handlebar comprises a stem connected to said steerer tube, wherein the first control unit is at least partially mounted to and/or accommodated within said stem. The stem may comprise an angled part and a substantially upright part, preferably connected via a bended tubular section. The lock nut is configured to adjust the steerer tube with respect to the handlebar and/or stem and/or head tube. The lock nut may comprise a radially extending part, which rests on a part of the stem and/or head tube. This way, by turning the lock nut, the tension exerted onto the steerer tube may be adjusted. Preferably, a part of the steerer tube extends beyond the head tube. Preferably the part of the steerer tube extending beyond the head tube is integrally formed with the part of the steerer tube accommodated inside the head tube. The steerer tube may extend at an upper side and/or at a bottom side beyond the head tube. Preferably, said steerer tube extends beyond the head tube in an upward direction. That is, the steerer tube is preferably longer compared to the head tube. For allowing a smooth steering movement, at least two bearings are arranged in the steering assembly. Preferably, said bearings are provided in between the steerer tube and the head tube, wherein, preferably, at least one bearing is located at a lower end surface of the head tube and at least one other bearing is located at an upper end surface of said head tube. This may allow a smooth movement, in particular rotation, of said components with respect to each other. A clamping sleeve is preferably arranged around at least a part, in particular a top section, of the steerer tube, and more preferably at a distance from the head tube. Preferably, said clamping sleeve is arranged around the part of the steerer tube that extends beyond the head tube. Preferably, said clamping sleeve extends, in an upward direction, at least partially beyond the steerer tube. The lock nut may at least partially abut the clamping sleeve. Preferably, the lock nut abuts the clamping sleeve at an end thereof.

By means of the co-acting threaded parts of the lock nut and steerer tube, the lock nut may pull the steerer tube in upward direction. This upward displacement will typically be limited by an abutment of the steerer tube and either a (lower) bearing and/or the head tube. Further tightening of the lock nut will lead to a downward force exerted onto the clamping sleeve, which leads to a pretensioned engagement between (a top end surface of) the clamping sleeve and the lock nut at one end surface of the clamping sleeve, and a pretensioned engagement between (a bottom end surfaced of) the clamping sleeve and either the (upper) bearing and/or the head tube. In this manner, the pretension exerted onto the at least two bearings may be adjusted. It is imaginable that the lock nut comprises a radially protruding ring part, wherein preferably a part of the ring abuts the clamping sleeve, at least in installed condition. By tightening the lock nut, the steerer tube may be pulled towards the lock nut, and hence increasing a tension exerted onto the bearings. By loosening the lock nut the steerer tube may be moved away from the lock nut, and hence decreasing a tension exerted onto the bearings. Moreover, said lock nut may be provided with a pin, extending perpendicularly to the radial ring, said pin comprising at least one through hole, for routing at least one cable therethrough. Preferably, said through hole comprises a diameter between 0.5 cm and 2.5 cm, more preferably between 1.0 cm and 2.0 cm. Said pin may be provided with an external thread, for co-acting with an internal thread of the steerer tube. Said internal thread provided onto the steerer tube may be provided on an integral part of the steerer tube. Preferably, said internal thread of the steerer tube is provided on a internally protruding ring or cylinder, which may be integral part of the steerer tube. The clamping sleeve may be clamped by means of one or more fastening elements, such as bolts, screws, and/or nuts. The same fastening elements, such as the bolts, screws, and/or nuts, may be used for clamping the clamping sleeve and the stem of the handlebar. During tightening of these fastening elements, the clamping sleeve is preferably at least partially deformed. This deformation may be (very) small deformation. The clamping sleeve is preferably hollow and at least partially cylindrically shaped. Preferably, the clamping sleeve comprises at least one slot or groove, preferably at least one longitudinal slot which may or may not connecting opposing end surfaces of the clamping sleeve. Such slot(s) and/or groove(s) facilitate deformation of the clamping sleeve during fastening. Said fastening elements may simultaneously clamp the stem of the handlebar and the clamping sleeve. It is conceivable that the embodiments described with respect to the lock nut and/or steerer tube may be applied independent of the other embodiments of the present invention, and may be applied with or without the first control unit and/or the second control unit.

Preferably, at least one accessory is chosen from the group consisting of: a light source, an array of light sources, a display, an electronic shifter, an electronic brake, an electronic bell, an electronic horn, a visual projector, a button, and/or a sound speaker.

In a preferred embodiment, the first control unit is at least partially, preferably substantially entirely, accommodated within the steering assembly, preferably in the handlebar, more preferably in a stem portion of the handlebar. In this manner, the first control unit is at least partially protected by the steering assembly. The first control unit may be entirely surrounded (fully enclosed) by the steering assembly. However, it may be favourable in case the first control unit is partially exposed. This not only facilitates maintenance and/or replacement of the first control unit, but also allows the control unit to be provided with one or more electronic accessories, such as one or more (environmental) sensors, such as a humidity sensor and/or a temperature sensor and/or an air analysis sensor, that are configured to interact and/or to be exposed to the surrounding atmosphere for measuring values relating to at least one environmental related parameter. Preferably, the exposed part of the control unit is substantially positioned flush with an adjacent outer surface of the steering assembly, preferably with an adjacent outer surface of the steering the handlebar, more preferably with an adjacent outer surface of a stem portion of the handlebar. Such a flush orientation reduces the risk of damaging of the first control unit and may contribute to the aerodynamic properties of the electric bicycle, which may lead to energy saving. As the outer surface of the steering assembly is preferably at least partially curved, the exposed part of the first control unit is preferably at least partially curved as well

Preferably, the exposed part of the first control unit is at least partially, preferably entirely, positioned at a front side of the steering assembly, preferably a front side of the handlebar, more preferably a front side of a stem portion of the handlebar. Additionally or alternatively, the exposed part of the first control unit is facing in an inclined downwardly facing direction and/or forward direction and/or away from the bicycle frame. Such an orientation of the exposed part is typically favourable to catch a genuine (pure) air flow stream during riding of the bicycle for analysis purposes, for example to determine the environmental temperature, the environmental humidity and/or at least a part of the chemical composition of the environmental atmosphere (e.g. the O2 content and/or the CO2 content and/or the (degree and/or type of) air pollution (such as the NOx content)).

Preferably, the first control unit is accommodated within a circumferential wall of the handlebar, in particular of a stem portion of the handlebar, is provided with an insertion opening for insertion of the first control unit into the handlebar. Preferably, at least one circumferential wall section surrounding the insertion opening has a reduced wall thickness. Additionally or alternatively, at least one circumferential wall section opposite to the insertion opening and facing the insertion opening has a reduced wall thickness. These one or more sections or zones with a reduced wall thickness lead(s) to an increase of the enclosed internal volume of the steering assembly, which creates more space for the first control unit to be at least partially accommodated with said space. This increased internal volume also allows the first control unit to be designed in a more robust manner. In mounted condition of the first control unit, the insertion opening will typically be filled with an exposed part of the first control unit (as indicated above).

According to an advantageous embodiment of the present invention the bicycle comprises at least two wheels connected to said bicycle frame, at least one an electric motor configured to drive at least one wheel, wherein the first bicycle control unit and/or the second bicycle control unit is configured to control, directly or indirectly, said at least one electric motor. Preferably, the bicycle further comprises at least one rechargeable battery attached to and/or accommodated within the bicycle frame, wherein said battery is configured to store at least a part of the energy to be supplied to the at least one electric motor. To this end said battery is connected, directly or indirect, to said motor and to at least one bicycle control unit, such as the first bicycle control unit and/or the second bicycle control unit, configured to control the power supply from the at least one battery to at least one wheel. Preferably, the bicycle comprises a charging device electrically connected or connectable, directly or indirectly, to at least one battery and to at least one bicycle control unit, wherein the charging device comprises at least one charging port configured to co-act with an external charger to transfer electric energy from said external charger via the charging device to at least one battery.

The bicycle may further comprise foot pedals, wherein said pedals are, directly or indirectly, connected to a crank set of the bicycle for propelling the bicycle. In particular, the bicycle is a pedal operable electric bicycle. Moreover, the bicycle comprises preferably at least one electromotor to drive at least one wheel of the bicycle. It is preferred that the bicycle comprises a pedal-operated manpower driven system and an electromotor driven system in parallel to each other, wherein at least one bicycle control unit is configured to control the output of the electromotor driven in response to a pedal depressing force of the manpower driven system.

The present invention is further related to a first control unit and/or a steering system for use in a bicycle according to the invention. The same benefits apply to the service port according to the invention as have been stipulated with respect to the electric bicycle above. These benefits are therefore incorporated by reference with respect to the first control unit and/or the steering system.

Further preferred embodiments of the invention are described in the non-limitative set of embodiments presented below:
1. Electric bicycle, comprising:
   a bicycle frame, comprising a, preferably substantially vertically extending and/or inclined, frame part, in particular a head tube,
   a steering system, comprising:
      a steering assembly, comprising:
         a fork comprising a steerer tube being at least partially inserted in said frame part, wherein said fork is rotatably secured to said frame part, and
         a handlebar fixedly connected to said steerer tube,
      a plurality of electronic accessories mounted to said steering assembly, in particular to said handlebar,
   at least one first control unit, in particular an accessory control unit, mounted to said steering assembly, in particular to said handlebar, wherein, preferably, at least one accessory cable, in particular each accessory cable, is preferably at least partially, more preferably entirely, accommodated within the steering assembly, wherein each of a plurality of electronic accessories is connected by at least one accessory cable to said first control unit, and wherein said first control unit is connected to at least one control cable and/or at least one power cable, and wherein, preferably, at least one control cable, if applied, is configured to also act as power cable; and wherein the number of said connected accessory cable exceeds the total number of connected control cables and/or power cables; and
      wherein the bicycle preferably further comprises at least one second control unit, in particular a main control unit, mounted to said bicycle frame, wherein said first control unit is connected by said at least one control cable and/or said at least one power cable, directly or indirectly, to said second control unit.
2. Electric bicycle according to embodiment 1, wherein the first control unit is connected to the second control unit by means of a single control cable and/or power cable.
3. Electric bicycle according to embodiment 1 or 2, wherein the first control unit comprises a plurality of accessory connectors, each of which being configured to be connected to at least one accessory.
4. Electric bicycle according to any of the preceding embodiments, wherein the first control unit comprises a single control unit connector configured to be connected, directly or indirectly to the second control unit.
5. Electric bicycle according to any of the preceding embodiments, wherein at least one accessory cable is configured to transfer power from the first control unit to the accessory connected to said accessory cable.
6. Electric bicycle according to any of the preceding embodiments, wherein at least one accessory cable is configured to transfer data between the first control unit and the accessory connected to said accessory cable.
7. Electric bicycle according to any of the preceding embodiments, wherein at least one control cable is configured to transfer power from the second control unit to the first control unit.
8. Electric bicycle according to any of the preceding embodiments, wherein at least one control cable is configured to transfer data between the second control unit and the first control unit.
9. Electric bicycle according to embodiment 8, wherein at least one control cable is a bicycle bus cable, in particular a CAN bus cable, and/or is connected to a bicycle bus, in particular a CAN bus, wherein said bicycle bus is connected to the second control unit.
10. Electric bicycle according to any of the preceding embodiments, wherein the first control unit comprises a communication protocol converter for mutual conversion between CAN bus signal and at least one serial signal, preferably a multipath serial signal.
11. Electric bicycle according to any of the preceding embodiments, wherein at least one control cable and/or at least one accessory cable comprises a plurality of wires, such power wires and data wires.
12. Electric bicycle according to any of the preceding embodiments, wherein the at least one control cable and/or power cable is partially accommodated within said frame part, in particular said head tube, and is partially accommodated within at least one connecting adjacent frame part, such as a top tube or down tube, of the bicycle frame.
13. Electric bicycle according to any of the preceding embodiments, wherein the first control unit comprises a shielding element, which shielding element is at least partially exposed.
14. Electric bicycle according to any of the preceding embodiments, wherein the at least one control cable and/or power cable comprises at least one coiled section and/or at least one spiralled section.
15. Electric bicycle according to any of the preceding embodiments, wherein the steering assembly further comprises a lock nut, wherein said lock nut comprises a threaded section configured to co-act with a threaded section of the steerer tube.
16. Electric bicycle according to embodiment 15, wherein the steerer tube comprises an internal threaded section, and wherein the lock nut comprises an externally threaded segment.
17. Electric bicycle according to any of the preceding embodiments, wherein the first control unit comprises at least one environmental sensor for measuring values relating to at least one environmental related parameter.
18. Electric bicycle according to embodiment 17, wherein the environmental sensor is chosen from the group consisting of: a temperature sensor, a light sensor, an oxygen sensor, a carbon dioxide sensor, and an audio sensor, such as a sound sensor or noise sensor.
19. Electric bicycle according to embodiment 17 or 18, wherein the first control unit and/or the second control unit is programmed to generate at least a part of at least one control signal based upon at least value measured by at least one sensor, wherein said control signal is configured to control at least one electronic component, such as an electronic accessory, of the electric bicycle.
20. Electrical bicycle according to embodiment 13 and one of embodiments 17-19, wherein the shielding element comprises holes for exposing the one or more sensors, positioned behind said shielding element, to the environment.
21. Electric bicycle according to any of the preceding embodiments, wherein the first control unit comprises at least one, preferably exposed and/or accessible, powered device charging port for charging an external device, such as a smartphone, wherein the device charging port is preferably covered or coverable by at least one device charging port cover element.
22. Electric bicycle according to any of the preceding embodiments, wherein the first control unit comprises at least one, preferably exposed and/or accessible, bicycle charging port configured to co-act with an external charging port of a charging terminal for charging said bicycle via said charging terminal, wherein the bicycle charging port is preferably covered or coverable by at least one bicycle charging port cover element.
23. Electric bicycle according to any of the preceding embodiments, wherein the first control unit comprises at least one, preferably exposed and/or accessible, servicing port configured to co-act with an external servicing port of a servicing terminal for servicing said bicycle via said servicing terminal, wherein the servicing port is preferably covered or coverable by at least one servicing port cover element.
24. Electric bicycle according to any of the preceding embodiments, wherein the first control unit comprises at least one generator for generating at least one visual and/or auditory signal.
25. Electric bicycle according to any of the preceding embodiments, wherein the second control unit is partially exposed.
26. Electric bicycle according to any of the preceding embodiments, wherein the handlebar comprises a stem connected to said steerer tube, wherein the first control unit is at least partially mounted to and/or accommodated within said stem.
27. Electric bicycle according to any of the preceding embodiments, wherein the handlebar comprises two opposing user grips mutually connected by a tubular body, wherein at least one, preferably each, accessory cable is guided into said tubular body, wherein preferably at least one accessory cable is partially enclosed by one of the grips and the tubular body.
28. Electric bicycle according to embodiment 27, wherein at least one accessory is positioned adjacent or close to one of the grips, and wherein preferably at least one accessory is positioned adjacent or close to one of the other grips.
29. Electric bicycle according to any of the preceding embodiments, wherein at least one accessory is chosen from the group consisting of: a light source, an array of light sources, a display, an electronic shifter, an electronic brake, an electronic bell, an electronic horn, a visual projector, a button, and/or a sound speaker.
30. Electric bicycle according to any of the preceding embodiments, wherein the bicycle further comprises:
   at least two wheels connected to said bicycle frame,
   at least one an electric motor configured to drive at least one wheel,
   wherein said first bicycle control unit is configured to control, directly or indirectly, said at least one electric motor,
31. Electric bicycle according to embodiment 30, wherein the bicycle further comprises at least one rechargeable battery attached to and/or accommodated within the bicycle frame, wherein said battery is configured to store electric energy to be supplied to the at least one electric motor.
32. Electric bicycle according to any of the preceding embodiments, wherein the bicycle comprises foot pedals, wherein said pedals are, directly or indirectly, connected to a crank set of the bicycle for propelling the bicycle.
33. Electric bicycle according to any of the preceding embodiments, wherein the bicycle is a pedal operable electric bicycle.
34. Electric bicycle according to any of the preceding embodiments, wherein the bicycle comprises at least one electromotor to drive at least one wheel of the bicycle.
35. Electric bicycle according to any of the preceding embodiments, wherein the bicycle comprises a pedal-operated manpower driven system and an electromotor driven system in parallel to each other, wherein at least one bicycle control unit is configured to control the output of the electromotor driven in response to a pedal depressing force of the manpower driven system.
36. Electric bicycle according to any of the preceding embodiments, wherein the first control unit is accommodated within the steering assembly, preferably in the handlebar, more preferably in a stem portion of the handlebar.
37. Electric bicycle according to any of the preceding embodiments, wherein the first control unit is partially exposed.
38. Electric bicycle according to embodiment 37, wherein the exposed part of the control unit is substantially positioned flush with an adjacent outer surface of the steering assembly, preferably with an adjacent outer surface of the steering the handlebar, more preferably with an adjacent outer surface of a stem portion of the handlebar.
39. Electric bicycle according to one of embodiments 37-38, wherein the exposed part of the first control unit is at least partially curved.
40. Electric bicycle according to one of embodiments 37-39, wherein the exposed part of the control unit comprises at least one electronic accessory, preferably at least one environmental sensor for measuring values relating to at least one environmental related parameter.
41. Electric bicycle according to one of embodiments 37-40, wherein the exposed part of the first control unit is at least partially, preferably entirely, positioned at a front side of the steering assembly, preferably a front side of the handlebar, more preferably a front side of a stem portion of the handlebar.
42. Electric bicycle according to one of embodiments 37-41, wherein the exposed part of the first control unit is facing in downward direction and/or forward direction and/or away from the bicycle frame.
43. Electric bicycle according to any of the preceding embodiments, wherein the first control unit is accommodated within a circumferential wall of the handlebar, in particular of a stem portion of the handlebar, is provided with an insertion opening for insertion of the first control unit into the handlebar.
44. Electric bicycle according to embodiment 43, wherein at least one circumferential wall section surrounding the insertion opening has a reduced wall thickness.
45. Electric bicycle according to embodiment 43 or 44, wherein at least one circumferential wall section opposite to the insertion opening and facing the insertion opening has a reduced wall thickness.
46. Electric bicycle according to any of the preceding embodiments, wherein each electronic accessory is a powered electronic accessory, and wherein each electronic accessory comprises at least one power-consuming electronic component.
47. Electric bicycle according to any of the preceding embodiments, wherein the first control unit is configured as power hub to distribute and/or to control power (to be) provided to one or more accessory cables and/or to one more accessories.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following non-limitative drawings, wherein:

FIG. 1 shows a part of a handlebar of a bicycle comprising a first control unit according to the invention;

FIG. 2 shows a different perspective of the first control unit as shown in FIG. 1;

FIG. 3 shows a cross-sectional view of the handlebar along line segment A-A′ as indicated in FIG. 1;

FIG. 4 shows a side view of a part of the bicycle according to the present invention; and

FIG. 5 shows a schematic overview of a bicycle according to the invention.

### DESCRIPTION OF THE INVENTION

FIG. 1 shows a part of a handlebar 1 of a bicycle 200 according to the present invention. In this figure only the contours of the handlebar 2 are shown for indicative purposes. The handlebar 2 in this non-limitative embodiment comprises a stem portion 7 which is fixedly connected to a steerer tube 9 of the bicycle. The steerer tube 9 may be connected to and/or makes part of a fork (not shown) of the bicycle for steering the bicycle. The steerer tube 9 is preferably at least partially housed inside the head tube 6 of a frame of the bicycle. The assembly of the handlebar 2 and the steerer tube is normally rotatably mounted to and/or co-acting with the head tube 6. The handlebar 2 is provided with one or more electronic accessories 4, 5, such as a display 5 and/or light 5, and a button 4 and/or user input device 4. According to this embodiment, the accessories 4, 5, are located adjacent to the grip 10 of the handlebar 2, such that a user of the bicycle may easily reach the accessories 4, 5. The electronic accessories 4, 5 are electronically connected to a first control unit 100. Preferably, the electronic accessories 4, 5, are connected to the first control unit 100 via wires 102, preferably different wires 102, such as accessory cables 102. This allows the accessories 4, 5 to be independently controlled. Also, if one of the accessories 4, 5 breaks down, it does not cause the others to be out of signal and/or out of power. The cables 102 of the different accessories 4, 5, are preferably at least partially routed inside the handlebar 2. Conventionally, the wires or accessory cables 102 are all routed outside the handlebar, and guided, via e.g., frame tubes, towards the preferred connecting location. The first control unit 100 according to the present invention preferably allows for less wires to be routed through the head tube 6 and/or into the bicycle frame of the bicycle, compared to the number of wires routed in a direction away from the bicycle frame, such as into the handlebar and/or around the handlebar. Routing of a wire 102 through the head tube has proved to be difficult and prone to damage. In particular since the steerer tube 9 is housed at least partially in the head tube 6. Preferably, the head tube 6 is a stationary tube, whereas the handlebar 2 and the steerer tube 9 may be movable with respect to said head tube 6. Routing wires 102 through the components which move with respect to each other induces an increased amount of wear and tear. Due the wires being pressed to each other and to the steerer tube 9 the wires may wear fast. In order to at least partially overcome the problem of excessive wear of the wires a first control unit 100 is provided in a part of the handlebar 2, in particular inside the stem 7 of the handlebar 2. The control unit is connected, preferably via separate accessory cables 102, to each of the accessories 4, 5, of the handlebar. Although each side of the handlebar 2 is in this non-limitative embodiment provided with 2 accessories 4, 5, it is conceivable that more accessories may be applied. Said first control unit 100 is connected, preferably via a single cable 101 to a main control unit (not shown) and/or to a battery. The cable 101 typically act as control cable, as power cable, or as a combination thereof (i.e. a combined power and control cable, and/or a powered control cable). The amount of wires 102 between the accessories 4, 5, and the first control unit 100 exceeds the amount of wires between the first control unit 100 and the main control unit. The single cable 101 may be connected to the first control unit 100 via a connector 103. Said single control cable 101 is routed at least partially through the steerer tube 9 and/or through the head tube 6. Since the first control unit 100 is connected to the main control unit only via a single control cable 101, it is possible to route said cable through the moving steerer tube 9 and as such at least partially eliminating mutual friction of cables. In this respect the location of the first control unit 100 is important. Preferably, said first control unit 100 is at least partially mounted to and/or accommodated within a part of the handlebar 2 and/or the stem 7. Beside comprising a number of electronic accessories 4, 5, the handlebar 2 and/or the first control unit 100 may be provided with a generator for generating at least one visual and/or auditory signal.

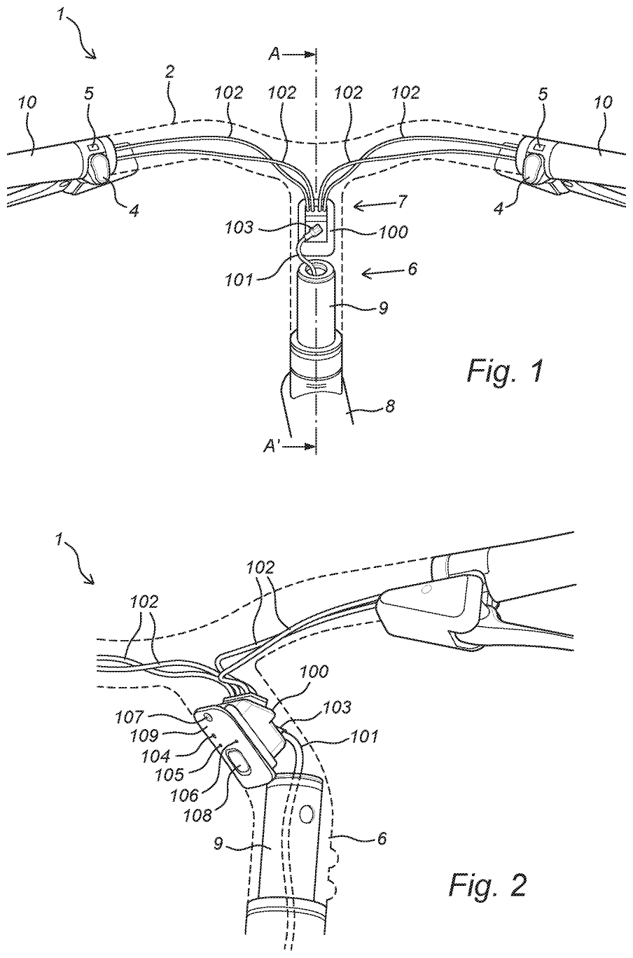

FIG. 2 shows a different perspective of the first control unit 100 as shown in FIG. 1. In this figure, the handlebar 2 is not indicated for illustrative purposes. The figure shows a bottom side, or an exposed surface 109, of the first control unit 100. The first control unit 100 may be mounted to the handlebar 2, or the stem 7 which is connected to the handlebar 2 via one or more mounting elements 107, such as screws or bolts. The exposed outer surface 109, which may function as a shielding element 109, of the first control unit 100 preferably comprises at least one environmental sensor 104, 105, 106. In this non-limitative embodiment, the first control unit 1 comprises a light sensor 104, an oxygen and/or carbon dioxide sensor 105, and a temperature sensor 106. It is furthermore conceivable that additional and/or alternative sensors are provided. The first control unit 100, or the second control unit may be configured for generating a control signal for the accessories 4, 5, based on data retrieved from at least one sensor 104, 105, 106. Said exposed surface may additionally comprise a connector 108, which may be a port for charging an external device such as a smartphone. Said connector 108 may also be a data logging port, which allows logging of data to an external device and/or a service terminal. This figure further shows that the single control cable 101 is routed through the steerer tube 9. Sufficient space remains available for the single cable 101 to move between the walls of the steerer tube 9 in order to reduce the friction between the control cable 101 and the steerer tube 9. It is conceivable that the control cable 101 is substantially equally thick as one of the accessory cables 102. This may be achieved since the first control unit is configured for converting the control signal received from the control cable 101 into a plurality of individual accessory signals. As such, it is possible to route only a single control cable 101 of a relatively small diameter through the steerer tube 9 which may reduce the friction.

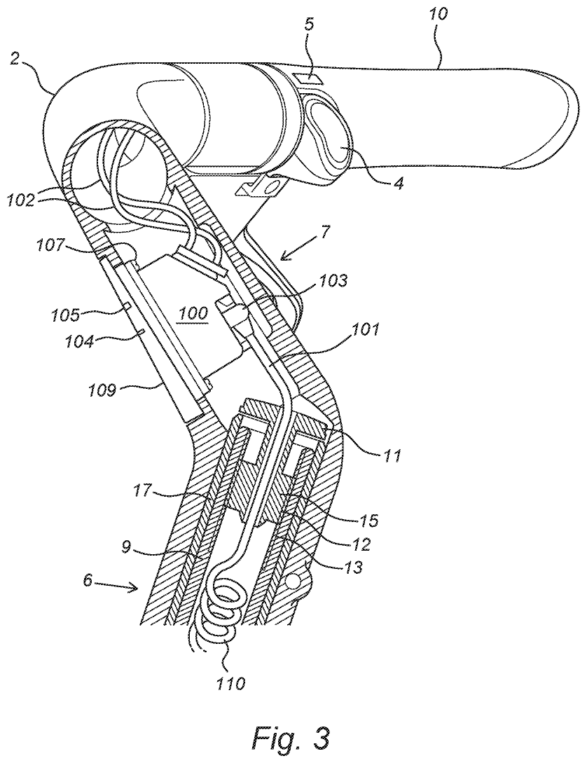

FIG. 3 shows a cross-sectional view of the handlebar 2 along line segment A-A′ which is indicated in FIG. 1. The figure shows a half of the first control unit 100. Two accessory cables 102 routed through the handlebar 2 towards an electronic accessory 4, 5. The accessory cables 102 are connected to the electronic accessories 4, 5, on one side, and to the first control unit 100 on the other side. Said accessory cables 102 may be connected to a printed circuit board, e.g., by means of soldering. Or may be connected to the first control unit 100 via an individual connector or a common connector. A separate connector 103 connects the single control cable 101 to the second control unit, in particular the main control unit. Said single control cable 101 is in particular routed through the steerer tube 9. In order to reduce the tension, at least a part of the single control cable 101 is coiled 110. Preferably, said coiled part 110 of the single control cable 101 is accommodated inside the steerer tube 9. In order to secure the steerer tube 9 with respect to the handlebar 2, a lock nut 11 may be used. Preferably, said lock nut comprises a threaded section 12 which is configured to co-act with a threaded section 13 of the steerer tube 9. Around (a top section of) the steerer tube 9 a clamping sleeve 17 is provided. Said clamping sleeve preferably extends, at least in upward direction, at least partially beyond a top end surface of the steerer tube 9. This typically leads to a (small) height difference between the top end surfaces of the steerer tube 9 and the clamping sleeve 19, which facilitates to pull and hence to secure the steerer tube 9 In this non-limitative embodiment, the lock nut 11 comprises a protruding part 15, said protruding part, or pin, 15 having a through-hole for routing therethrough a part of the control cable 101. Preferably, an external portion of the protruding part, or pin, 15 is threaded 12. Said externally threaded part 12 of the protruding part 15 configured to co-act with an internally threaded part 13 of the steerer tube 9. Said internally threaded part 13 of the steerer tube 9 may protrude with the internal surface of the steerer tube 9. The lock nut 11 may arrange a preload to the steerer tube 9. The lock nut 11 may abut against a part, typically said top end surface, of the clamping sleeve 17. This facilitates to apply a pretension (bias) exerted onto the bearings 16 (not shown). By tightening the lock nut 11, the steerer tube 9 may be pulled and/or displaced towards the lock nut 11, as a result of which the clamping sleeve 17 will be pushed in downward direction towards the bearings 16 and will typically exert a (pre) tension onto the bearings 16. By loosening the lock nut 11 the steerer tube 9 may be moved away from the lock nut, and hence decreasing a tension exerted onto the bearings 16.

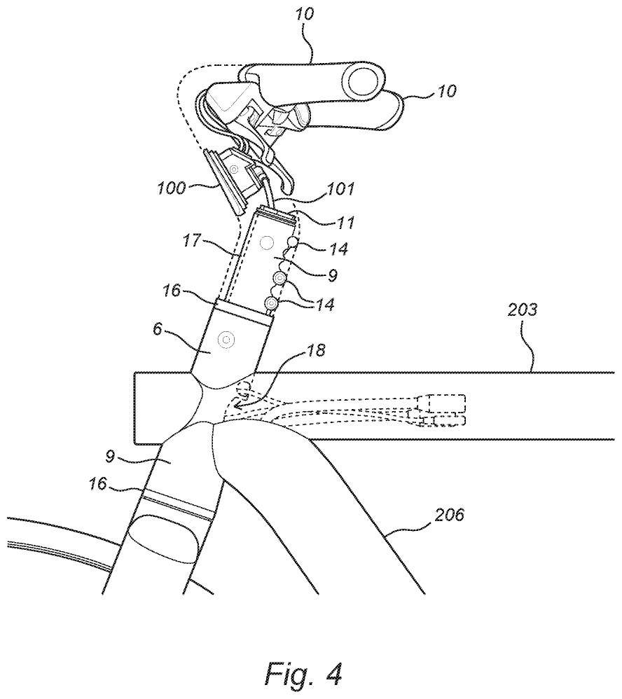

FIG. 4 shows a side view of a part of the bicycle 200 according to the invention, as also shown in the previous figures. For illustrative purposes the handlebar is not shown in this figure. The top tube 203 and head tube 6 are depicted partially translucent for indicative purposes. This allows the steerer tube 9 to be visible inside the head tube 6. The steerer tube 9 comprises a protruding part 9 which extends upwardly beyond the head tube 6. In order to allow for a smooth movement of the steerer tube 9 with respect to the head tube 6 two bearings 16 are provided for. Said bearings 16 allow the mutual movement of the steerer tube 9 with respect to the stationary head tube 6. Both bearings 16 are arranged inside the head tube 6. Around a part of the steerer tube 9, in particular the part extending upwardly beyond the head tube, a clamping sleeve 17 is provided. Preferably, said clamping sleeve 17 extends, at least in an upward direction, beyond the steerer tube 9. The lock nut 11 may abut against the upwardly facing edge of the clamping sleeve 17, such that by tightening and/or loosening the lock nut 11 a tension exerted onto the bearings 16 may be respectively increased and/or decreased. The clamping sleeve 17 may be clamped by means of one or more fastening elements 14, such as bolts or screws, and optionally nuts By tightening the fastening elements 14 the clamping sleeve 17 will be slightly deformed, which leads to a clamping effect. To this end, the clamping sleeve 17 preferably comprises a hollow cylindrical body provided with at least one longitudinal slot, which may or may not connected end surface of said cylindrical body. This leads to an interrupted hollow cylindrical body. It is even imaginable that the clamping sleeve comprises and/or is formed by at least two partially-cylindrical shells, such as half-cylindrical shells. The same fastening elements 14 may be used for clamping the clamping sleeve 17 and the stem 7 of the handlebar 2. Preferably, the steerer tube 9 comprises at least one lateral opening 18, for routing therethrough at least the at least one control cable 101. Said lateral opening 18 allows the control cable 101 to enter the top tube 203 and/or the bottom tube 203 (or another tube) of the bicycle frame. To this end, the lateral opening 18 of the steerer tube 9 debouches in an opening of the top tube 203 and/or bottom tube 206, preferably at an intersecting location thereof.

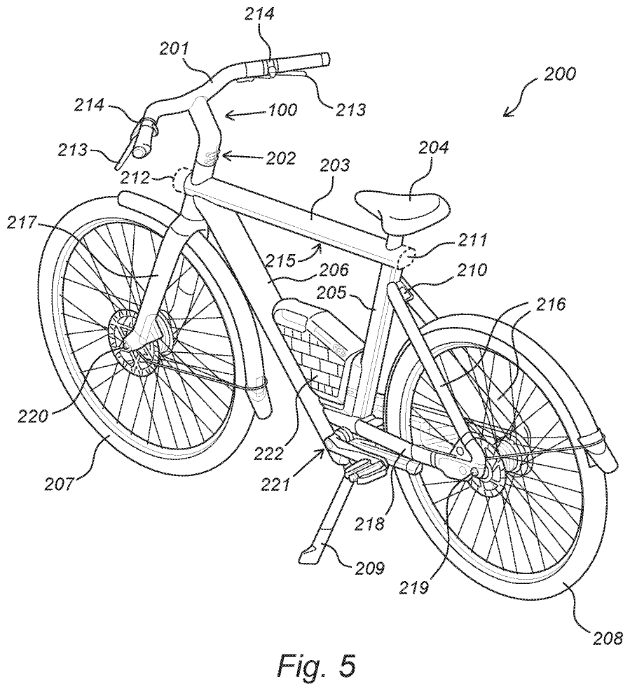

FIG. 5 shows a schematic overview of a bicycle 200 according to the invention. The bicycle 200 comprises a frame comprising a top tube 203, a seat tube 205, a bottom tube 206, a pair of seat stays 216, and a pair of chain stays 218. At the rear axis 219 a rear wheel 208 is rotatably arranged. The rear wheel may be powered by a used via a crank set 221. In order to drive de bicycle 200, the front side of the bicycle may comprise a handlebar 201, which may be rotatable with respect to the head tube 202 of the bicycle. The handlebar 201 may rotate the front wheel 207 which is arranged rotatably on a front axis 220. Said front wheel 207 may be held into place by means of the fork 217 which is rotatably coupled to the handlebar 201 of the bicycle 200. The handlebar 201 may be provided with a brake system 213 for allowing a user to apply a braking force. The handlebar 201 may comprise a first control unit 100, preferably arranged in a stem of the bicycle. Said first control unit may allow the accessory cables of the electronic accessories of the handlebar to be routed at least partially, preferably substantially entirely inside the frame of the bicycle 200. The first control unit 100 allows to reduce the amount of cables running through a steerer tube. One or more optical feedback units 214 may be arranged on and/or in the handlebar 201 for providing the user with optical feedback related to a bicycle status. Inside the bottom tube 206 a primary battery may be arranged for driving at least one electric motor which is arranged in the front axis 220 and/or rear axis 219. Optionally, a secondary battery 222 may be provided for extending the range of the bicycle 200. The primary battery inside the bottom tube 206 and/or the secondary battery 222 may be charged via a charging port 210 of the bicycle 200. The charging port 210 is arranged on a rear side of the bicycle in order to be easily accessible for a user. In this particular embodiment, the charging port 210 is arranged between the pair of seat stays 216 and attached to the seat tube 205 of the bicycle 200. In order for easily connecting the bicycle 200 to an external service device a service port 215 may be provided. In this embodiment the service port 215 is provided on a bottom side of the top tube 203 of the bicycle. Inside the top tube 203 at least one bicycle control unit may be provided. It is imaginable that at least one exposed exterior surface of at least one frame part comprises at least one antenna system. Said antenna system may be directly or indirectly mounted to said bicycle frame 203, 205, 206, 212, 216. The seat tube 205 further accommodates the seat post which may be attached to the saddle 204 of the bicycle 200. In order to increase the visibility of the user of the bicycle 200 during the evening or in the night time, the bicycle 200 may be provided with a front light module 212 and/or a rear light module 211. Said front light module 212 and rear light module 211 may allow for dynamic light patterns and/or for emitting light in at least a left and/or right direction. The bicycle 200 as shown in this figure is merely illustrative for the components thereof. It is explicitly noted that some aspects of the bicycle 200 as shown in this figure may be chosen by way of design. In particular shapes of the light modules 212, 211 may at least partially be shaped by design. Moreover, the shape of the tubes 202, 203, 205, 206 of the bicycle may also at least partially be chosen by way of design. Hence, the aesthetical appearance of the depicted embodiment are matters of design choice and can be varied or eliminated as desired.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component. By “complementary” components is meant that these components are configured to co-act with each other. However, to this end, these components do not necessarily have to have complementary forms. The verb “comprise” and conjugations thereof used in this patent publication are understood to mean not only “comprise”, but are also understood to mean the phrases “contain”, “substantially consist of”, “formed by” and conjugations thereof.

It will be apparent that the invention is not limited to the working examples shown and described herein, but that numerous variants are possible within the scope of the attached claims that will be obvious to a person skilled in the art. The aesthetical appearance and design of the working examples or details thereof, in particular as shown in the appended figures, is not technically determined, unless indicated otherwise, and is merely incorporate to demonstrate and clarify the inventive concept(s) described herein. Hence, the aesthetical appearance of the depicted embodiments are matters of design choice and can be varied or eliminated as desired. The owner of this patent document does moreover not disclaim any other rights that may be lawfully associated with the information disclosed in this document, including but not limited to, copyrights and designs associated with, based upon, and/or derived from the appended figures.

1. An electric bicycle, comprising:
a bicycle frame, comprising a frame part,
a steering system, comprising:
a steering assembly, comprising:
a fork comprising a steerer tube being at least partially inserted in said frame part, wherein said fork is rotatably secured to said frame part, and
a handlebar fixedly connected to said steerer tube,
a plurality of electronic accessories mounted to said steering assembly,
at least one first control unit, mounted to said steering assembly, wherein each of a plurality of electronic accessories is connected by at least one accessory cable to said first control unit, wherein each accessory cable is entirely accommodated within the steering assembly, and wherein said first control unit is connected to at least one control cable and/or at least one power cable; and wherein the number of said connected accessory cable exceeds the total number of connected control cables and/or power cables; and
wherein the bicycle further comprises at least one second control unit mounted to said bicycle frame, wherein said first control unit is connected by said at least one control cable and/or said at least one power cable, directly or indirectly, to said second control unit.

2. The electric bicycle according to claim 1, wherein the first control unit is connected to the second control unit by means of a single control cable and/or power cable.

3. (canceled)

4. The electric bicycle according to claim 1, wherein the first control unit comprises a single control unit connector configured to be connected, directly or indirectly to the second control unit and/or wherein at least one accessory cable is configured to transfer power from the first control unit to the accessory connected to said accessory cable and/or wherein at least one accessory cable is configured to transfer data between the first control unit and the accessory connected to said accessory cable and/or wherein at least one control cable is configured to transfer power from the second control unit to the first control unit.

5-7. (canceled)

8. The electric bicycle according to claim 1, wherein at least one control cable is configured to transfer data between the second control unit and the first control unit.

9. (canceled)

10. The electric bicycle according to claim 1, wherein the first control unit comprises a communication protocol converter for mutual conversion between CAN bus signal and at least one serial signal.

11. The electric bicycle according to claim 1, wherein at least one control cable and/or at least one accessory cable comprises a plurality of wires.

12. The electric bicycle cording to claim 1, wherein the at least one control cable and/or power cable is partially accommodated within said frame part and is partially accommodated within at least one connecting adjacent frame part of the bicycle frame and/or wherein the first control unit comprises a shielding element, which shielding element is at least partially exposed and/or wherein the at least one control cable and/or power cable comprises at least one coiled section and/or at least one spiralled section.

13. (canceled)

14. (canceled)

15. The electric bicycle according to claim 1, wherein the steering assembly further comprises a lock nut, wherein said lock nut comprises a threaded section configured to co-act with a threaded section of the steerer tube, wherein the steerer tube comprises an internal threaded section, and wherein the lock nut comprises an externally threaded segment.

16. (canceled)

17. The electric bicycle according to claim 1, wherein the first control unit comprises at least one environmental sensor for measuring values relating to at least one environmental related parameter, wherein the environmental sensor is chosen from the group consisting of: a temperature sensor, a light sensor, an oxygen sensor, a carbon dioxide sensor, and an audio sensor and/or, wherein the first control unit and/or the second control unit is programmed to generate at least a part of at least one control signal based upon at least value measured by at least one sensor, wherein said control signal is configured to control at least one electronic component of the electric bicycle.

18-24. (canceled)

25. The electric bicycle according to claim 1, wherein the second control unit is partially exposed and/or wherein the handlebar comprises a stem connected to said steerer tube, wherein the first control unit is at least partially mounted to and/or accommodated within said stem.

26. (canceled)

27. The electric bicycle according to claim 1, wherein the handlebar comprises two opposing user grips mutually connected by a tubular body, wherein at least one, accessory cable is guided into said tubular body, wherein at least one accessory cable is partially enclosed by one of the grips and the tubular body.

28. (canceled)

29. The electric bicycle according to claim 1, wherein at least one accessory is chosen from the group consisting of: a light source, an array of light sources, a display, an electronic shifter, an electronic brake, an electronic bell, an electronic horn, a visual projector, a button, and/or a sound speaker.

30. (canceled)

31. (canceled)

32. The electric bicycle according to claim 1, wherein the bicycle comprises foot pedals, wherein said pedals are, directly or indirectly, connected to a crank set of the bicycle for propelling the bicycle and/or wherein the bicycle is a pedal operable electric bicycle and/or wherein the bicycle comprises at least one electromotor to drive at least one wheel of the bicycle and/or wherein the bicycle comprises a pedal-operated manpower driven system and an electromotor driven system in parallel to each other, wherein at least one bicycle control unit is configured to control the output of the electromotor driven in response to a pedal depressing force of the manpower driven system.

33-35. (canceled)

36. The electric bicycle according to claim 1, wherein the first control unit is accommodated within the steering assembly and/or, wherein the first control unit is partially exposed.

37-42. (canceled)

43. The electric bicycle according to claim 1, wherein the first control unit is accommodated within a circumferential wall of the handlebar is provided with an insertion opening for insertion of the first control unit into the handlebar, wherein at least one circumferential wall section surrounding the insertion opening has a reduced wall thickness and/or, wherein at least one circumferential wall section opposite to the insertion opening and facing the insertion opening has a reduced wall thickness.

44. (canceled)

45. (canceled)

46. The electric bicycle according to claim 1, wherein each electronic accessory is a powered electronic accessory, and wherein each electronic accessory comprises at least one power-consuming electronic component.

47. The electric bicycle according to claim 1, wherein the first control unit is configured as power hub to distribute and/or to control power to one or more accessory cables.

48. A first control unit for use in an electrical bicycle according to claim 1.

49. A steering system for use in an electrical bicycle according to claim 1.
